(19) United States
(12) Patent Application Publication
(10) Pub. No.: US 2007/0226163 A1
(43) Pub. Date: Sep. 27, 2007

(54) Innovation Bank; a Novel Method of Business Related to the Integration and Capitalization of Knowledge Assets

(76) Inventor: Daniel R. Robles, Edmonds, WA (US)

Correspondence Address: Daniel R. Robles, 15732 70th Ave West, Edmonds, WA, 98026, US

(21) Appl. No.: 11/622,945

(22) Filed: Jan. 12, 2007

Related U.S. Application Data
(63) Continuation of application No. 60/766,365, filed on Jan. 13, 2006.

(51) Int. Cl. G06N 5/02

(52) U.S. Cl. 706/50

(57) ABSTRACT

The invention described is a novel business method and system for matching most worthy knowledge surplus with most worthy knowledge deficit. The rate of change of information in this system is defined as knowledge. The rate of change of knowledge in this system is defined as innovation. A method and system of conducting enterprise is specified where knowledge is formatted to behave like a financial instrument embodied in an Innovation Bank and enabled by computer technology. An Innovation Bank is comprised of multiple applications of a Unit Business Method, a Knowledge Inventory, and an open source Problem Solving Environment. Each component is of specific formulation providing for integration of knowledge family elements. Enterprise is conducted through identification of knowledge surplus and deficit, creation, maintenance, accounting, analysis, exchange, and production of knowledge assets by an organization, society, and/or an individual. This business method therefore applies, involves, and advances the technological arts.

I hereby claim priority of earlier filed provisional patent No. 60/766,365

### BACKGROUND

Cited from the prior work of this inventor, the genesis of this invention was derived from research conducted in the border region of Mexicali, Mexico during the implementation of the North American Free Trade Act (NAFTA), specifically the Mutual Recognition Document for Engineering Professionals (MRD). The objective of the NAFTA MRD was to permit cross-border professional engineering practice, that is, to encourage the trade of “services” such as ‘engineering’ in addition to the trade of goods.

This constituted an attempt, in the purview of this inventor, to treat knowledge like a financial instrument in the context of international trade policy. Unfortunately, the MRD failed to sustain a market due to inadequate vetting mechanism and other elements. The treaty was ratified; however, the fundamental NAFTA MRD risk model failed to satisfy one or more of three essential market/regulatory requirements; 1. Can the risk exposure be identified? 2. Can the probability of the risk exposure occurring be determined? 3. Can the consequences of the occurrence of the risk exposure be quantified?

The NAFTA MRD most notably, by this inventor's observation, failed to answer these three questions, as such, the market for cross border engineering services failed. The present invention began as a means of correcting this market anomaly and was subsequently expanded and generalized to the current form upon extensive research, applications of component principles, proof of concept exercises, and continued development of prototype devices by this inventor.

### Field of Invention

The invention relates to the trade and management of knowledge assets characterized as financial instruments utilizing economic analysis methods in a computer enabled predictive matching system for heuristic knowledge assets application. Further utilizing a structure and format derived from combined disciplines of Knowledge Management, Innovation Theory, Econometrics, and Finance. More particularly, the method relates to a processing system herein termed an Innovation Bank capable of matching most worthy knowledge surplus to most worthy knowledge deficit, and combinations of the same, at a given probability for cost and quality (financial success) specified by entrepreneurial behavior in social networks. More specifically, the invention relates to a predictive method and system of enterprise that may be applied to a knowledge inventory for the purpose of best utilizing knowledge assets in convergence of public organization enabled by internet technologies.

Discussion

Global challenges will require a greatly increased rate of human innovation in order to resolve issues such as poverty, climate change, and health care, etc. As the political constraints are increasingly liberalized for the mobility of knowledge workers, the limiting factor will become the integration and capitalization of human ingenuity; i.e. knowledge assets. A means is required to organize knowledge assets and multiply innovation as a means of addressing future economic and development requirements.

The valuation and assessment of human capital remains largely unsuccessful because of the inadequacy of modern financial accounting systems. In short, money cannot think. By contrast, knowledge assets, in general, do not exist in a form that is directly recognized on a balance sheet or corporate financial statement. This invention describes a means, by way of a novel method and system, for monetizing human knowledge. This process for doing business produces a concrete, useful and tangible result due to the ability to reconcile with said financial instruments.

Improvement

It is evident that an innovation centric economy is demanded and emerging. National economies must find their way to higher levels on their respective development scale in order to compete effectively. However, modern enterprise struggles with the capturing and controlling of knowledge assets and their innovation potential thereby falling short in most efforts to accommodate generally acceptable accounting principles for tangible valuation of knowledge assets.

Knowledge Management is a known science defined by the process of identifying, selecting, and organizing the knowledge contained in a community of practitioners and presenting that knowledge in a manner that helps others comprehend and use that knowledge. A community of practice refers to people of the same interest or studies who come together to share an informal learning, ad hoc problem-solving, professional networking, and mutual support.

As companies grow, merge, divest and their human capital retire or transfer in a mobile job market, the task of capturing and retaining knowledge is increasingly difficult with higher order function of the knowledge worker. As a result, a majority of intellectual property goes unused, unrecognized, underutilized, or is considered intangible. The incremental innovations that, in aggregate, makes up the end-product are not licensed or otherwise captured in a tangible manner for application in local or tangential enterprise.

In a sense there is a static view of knowledge—that is, knowledge is only tangible in the final form, patent, copyright, end-product, process, or bill of materials. Knowledge is currently valued on a balance sheet as the difference between market value and replacement cost of material assets—and such assessment is only available to the publicly traded company in a sanctioned market where these data are vetted. Often we confuse the terms ‘intellectual capital’ with the terms ‘knowledge’ with ‘information’ with ‘innovation’ without establishing a domain and interaction for what is meant when using such terms.

It is not obvious, however, that each element that makes up the sum of an invention, patented or not, is a tangible subset that is generally absorbed by participants in the form of knowledge, experiential context, and wisdom. Knowledge subsets continue to be applied outside of the patent system in the form of Intellectual Capital, Social Capital, and Creative Capital long after the product is sold. Subsets of knowledge are continuously combined with other related or unrelated subsets in a dynamic and complex interplay toward a higher order, arguably, not unlike financial instruments under the progressive leadership of entrepreneurs.

Project valuation methods generally underestimate the return on innovation investments because of the failure to account for the market value of tangential knowledge, experiential context, and wisdom of the thinkforce. Net Present Value calculations generally assume that most parameters are held constant in time and space. In the real world, however, options may be exercised mid-course which allow for early abandonment or vastly increased returns as additional knowledge is accumulated. Capturing and capitalizing this future knowledge potential has been elusive and at best, inefficient.

Factors of Production

While it is the hallmark of a good manager to match the right person with the right job, existing methods of knowledge inventory are inefficient in accounting for the full range of knowledge assets possessed by an individual herein correlated to the knowledge families: Human Capital, Social Capital, and Creative Capital. Management judgment may be sufficient for correlating a limited and localized knowledge inventory relating to that manager's experience of recent history. The manager, however, would not necessarily be able to make an accurate judgment outside of this limited scope of their immediate domain, as such; knowledge ‘entropy’ is inevitable. Traditional management models inherently miss new and unique talents, their applicability to the present, opportunities for large scale integration, and multiplier cash flows associated with tangential industry applications.

When the manager retires, their knowledge of the knowledge inventory is retired as well much to the disservice of the talented persons whose knowledge possessions are no longer be accessed. Further, the integration of complex systems and the international application of knowledge assets across cultures, political boundaries, and ideologies, clearly demands more powerful analysis tools, capabilities, and methods for capitalization of knowledge assets.

Existing methods of knowledge management are largely inefficient at transposing knowledge across industries, technologies, cultures, languages, or political boundaries. Existing methods of knowledge management are inefficient in creating ownership of knowledge space thereby forgoing substantial entrepreneurial spirit associated with productivity of knowledge assets and the creation of new wealth.

While many knowledge management programs may succeed in extracting knowledge from an individual and capturing it in the form of processes, designs, methods, or white papers, etc., an efficient means for generalized dynamic innovation assessment and prediction—while still contained within the individual—remains elusive. Much of the knowledge stored in an experienced person is in fact their individual knowledge combined with awareness of knowledge inventory in their environment.

Knowledge Inventory

Most manufacturing business entities, for example, account with great precision all physical assets with a specific and complete inventory itemized in terms of cost, quantity, and quality. Many knowledge economy business entities operate in a relative absence of knowledge inventory similarly itemized in terms of cost, quantity, and quality.

An incomplete understanding of potential knowledge assets permits knowledge deficits and hides knowledge surpluses resulting in inefficient allocation of knowledge resources. A means is required for increasing the efficiency of knowledge markets through categorization, normalization, vetting, and dissemination of knowledge assets in a business method of specific monetary outcomes.

Identifying and managing specializations in knowledge assets and associated innovations is a difficult problem in the absence of the correct structure. Combinations of knowledge acting together in a heuristic stochastic interplay of intellect, communication, and creativity must be observed in a sociological medium regulated by culture, free-will, and human behavior. The shear number and variety of combinations and adaptations would be difficult, if not impossible, to objectively recognize, capitalize and commercialize in a form that meets the structural requirements of rational markets and their financial institutions. As such, the proposed structure is further designed to utilize powerful computational methods and mathematical models.

### BRIEF DESCRIPTION OF THE INVENTION

The method and system of the Innovation Banking System represents a knowledge management apparatus arising not from the art and science of human resources, rather, arising explicitly from the disciplines of Economics and Finance. The fact of “money” is an abstraction representing human productivity. Likewise, the fact of “innovation”, as defined herein, represents human productivity and may be treated tantamount to the fact of money as a tradable abstraction.

This invention relates to a business method of conducting knowledge enterprise in a manner that substantially increases the rate of change of knowledge, herein referred to as innovation, within a system herein termed an Innovation Bank. Increased rates of change of knowledge result from the application of a computer searchable knowledge inventory and Problem Solving Environment within an entrepreneur driven economic system for matching most worthy knowledge surplus with most worthy knowledge deficit.

A collection of component methods described herein and acting together in a system constitutes a useful, novel, and non-obvious business method. Where all components exist together and interact as described herein, the resulting embodiment is a rational predictor of innovation potential and contingency valuation associated with strategic application of knowledge assets and their derivative: innovation.

The resulting output, when combined with intuitive analysis constitutes the system for converting knowledge into a tangible quantity. Not unlike a Stock Market Analyst would survey vast amounts of financial data utilizing a variety of combinations of computer enabled and intuitive techniques, so too would the Innovation Analyst build a statistical valuation for the potential application for collections of intellectual assets.

The essential components of this business method are as follows:
I. A Knowledge Inventory of specific formulation such that independent variables characteristic of Knowledge are expressed in terms of a financial instrument; that is, having both cost and quality, risk and return, or, a value and a variance associated with said elements.
II. A Knowledge Catalog system accommodating of advanced computer search functionality and comprised of a verifiable numerical segmentation for breadth and depth of knowledge elements in an inventory.
III. A Knowledge Inventory system accommodating independent variables of human knowledge associated with the dependent variables of Intellectual Capital, Social Capital, and Creative Capital.
IV. A Knowledge Inventory Organization system where “Communities of Practice” associated with knowledge categories function as vetting mechanism (accrediting institutions) providing input to the system described above.
V. A Problem Solving Environment that returns probabilistic outcomes from regression equations derived from the inputs described above. A Percentile Search Engine “functionality” consists of computer enabled analysis tools or Intuitive mental model enabled tools, or both.
VI. A conceptual mathematical construct where “Innovation” is defined as the rate of change of Knowledge and where Knowledge is defined as the rate of change of information.
VII. An Innovation Bank as the collector of system components whose function is to identify, compare, separate or match specific knowledge surpluses with knowledge deficits based on the output of a problem solving environment within a business model closely resembling a financial banking business system.
VIII. A unit business method representing a single transaction of the Innovation Bank achieving a transfer from knowledge deficit to knowledge surplus utilizing the inventory, categorization, vetting mechanism, and probabilistic assessment components above.
IX. The construction of the Unit Business Method into Parallel and Series “circuits” each with specific utility. The further construction Unit Business Methods into networks of General Utility.
X. Feedback mechanism manifest in the weighting of independent variables within the probabilistic output constituting proprietary percentile search engine function as a means of improving the system, preserving ‘wisdom’, and engaging in the trade of said wisdom in the comparative, the alternate, or the amalgamated review capacity.

Whereas current Knowledge Economy search instruments return facts and data, future instruments of the Innovation Economy will return search results in the form of probabilities, contingencies, and pseudo-wisdom in a neural network. The utility of future system output is determined by the quality of current input; for this reason, the formation of the knowledge inventory is especially important.

The formulation of a knowledge inventory, the categorization of knowledge in a numerical catalogue, reconciliation of knowledge assets with written knowledge and financial instruments, reconciliation of Social Capital, Human Capital, and Creative Capital and specific probabilistic computational search criteria, together, constitute a Unit Business Method for an Innovation Bank. Specific constructs of the Unit Business Method constitute the Composite Business Method, a novel, non-obvious, and useful means for inducement of an innovation economy.

An advanced embodiment is that of an option generator; that is, a business method and system that generates scenarios, contingencies, and simulations for the allocation, preservation, and application of knowledge asset prior to, during, and/or after monetary expenditures for deployment of said knowledge assets in an innovation enterprise.

Innovation is defined herein as the rate of change of knowledge, where knowledge is defined as the rate of change of information. Embodiments of the method and system of an Innovation bank act on the improved knowledge inventory and institutions associated with the trade and monetization of knowledge. The method and system of an Innovation Bank in the context of an innovation economy provides an alternate and/or additional platform from which knowledge assets may be gathered, organized, inventoried, and traded.

It is the intended embodiment of this invention to augment, improve, and increase the value in existing methods and practices of innovation enterprise. Specific embodiments of the Innovation Bank assist individuals, companies and entrepreneurs (Innovation Practitioners) in the allocation and deployment of knowledge assets such that innovation enterprise becomes a more attractive financial venture or where financial support is required prior to the deployment of knowledge assets.

Such improvement arises through increased capacity for analysis of knowledge resources related to business environments in which independent variables normally associated with innovative outcomes may be assigned to dependent variables associated with knowledge families. It will remain proprietary to the practitioner, and their form of enterprise, how much and in what combinations knowledge assets produce a market competitive outcome. This invention will act in combination with the many subtle ways that talent is identified long term, short term, or in various degrees of proximity to the team.

It is intended to create a market environment for the products of innovation resulting from this method and system. The intent is to increase the rate of innovation, the efficiency of innovation, and the dissemination of innovation in, ultimately, a financial market. Many preferred embodiments have been identified in the description and background of the invention—this section will attempt to further the understanding of the functions and operations of an Innovation Bank through preferred embodiments as examples of utility.

### DESCRIPTION OF THE DRAWINGS

FIG. 1: Cascading Numerical Knowledge Inventory Structure comprised of classification, distribution, and variance constitutes the format of a financial instrument

FIG. 2: Problem Solving Environment comprised of Dependent Variables, sample Independent Variables, sample Communities of Practice, and a Knowledge Inventory Structure as specified in FIG. 1. These components, in this form, provide sufficient information to apply the calculus associated with financial and economic analysis.

FIG. 3: The Unit Business Method comprised of a Knowledge Inventory Surplus, a Knowledge Inventory Deficit, and Integration with a Problem Solving Environment.

FIG. 4: Series Composite Business Method; Knowledge Asset Development Cycle

FIG. 5: Parallel Composite Business Method; Virtuous Circle for Knowledge Assets

FIG. 6: Secondary Revenue for Tangential Innovation; the Multiplier Effect on Knowledge Assets as an embodiment of the Innovation bank

FIG. 7: Generalized Composite Business System; neural network (interdependence) of knowledge assets demonstrates nesting (archetypical triangle) and fault tolerance (dashed lines) yielding high output (thick lines) from low input (thin lines).

FIG. 8: Reconciliation of the Innovation Bank with Financial Bank; A virtuous circle constitutes the monetization of knowledge assets

FIG. 9: Innovation Bonds; Amalgamation of knowledge systems output monetized and divided equally in bond coupons for distribution as financial instruments of known value and variance applied to the funding of innovation

### DETAILED DESCRIPTION

New combinations of old knowledge create new knowledge. Many “inventions” have came about by combining two or more ideas or inventions in a novel, useful, and non-obvious manner. Continued development of an invention takes on a series of incremental improvement steps resolved from elemental innovation. Derived knowledge from the process of innovation is stored in knowledge inventories of persons and accounted, analyzed, and accessed in a problem solving space.

Essential to the description and interpretation of Innovation Banking Enterprise is the modeling of Innovation (N) as the derivative of knowledge (K) and the modeling of knowledge as the derivative of information (I); with respect to time, according to the following relationship:
I=dK/dt,
K=dN/dt

From the basis of this relationship among derivative quantities, the method and system of an Innovation Bank depends on the consistent mathematical interpretation of these components.

Further to this definition, as a means of reconciling factors of production for an Innovation Bank with the known, relevant, and useful discipline of knowledge management, the following novel relationships are necessary.

Information=Explicit Knowledge

Knowledge=Experiential Context

Innovation=Tacit Knowledge

These relationships among terms are necessary and hold throughout this description of a method and system of an innovation bank.

Explicit knowledge is a term introduced through the field of Knowledge management referring to category of knowledge that can be captured through written instruction, procedure, or process. Explicit knowledge in the construct of the Innovation Bank is equivalent to information; that which is written, readable, and captured in print or graphic media.

Experiential Context is the accumulation of personal experience in similar complex situations (that is, having numerous independent variables) that resolve in a variety of outcomes; the number of which becomes statistically significant over time. The witness or participant to a statistically significant number of outcomes gains facility in predicting the likely outcome of future events based on the experiential context of past events. Such awareness also provides the facility to identify deficits in experiential context thereby allowing the individual to ask appropriate questions regarding perceived deviations between the expected outcome and the actual outcome. In common terms, one is perceived to possess wisdom.

Tacit Knowledge is a term introduced through the discipline of Knowledge Management refers to the knowledge possessed by a person which cannot be expressed as simple information; that is, knowledge which cannot be captured as a process, work instruction, or procedure. A motorcycle racer or a medical surgeon exhibit tacit knowledge in the practice of their craft. Innovation economics further argues that on an incremental scale, tacit knowledge is a manifestation of a high rate of change of knowledge and therefore is interchangeable with “Innovation”.

Innovation is defined herein as the rate of change of knowledge. Intuitively, the moment of great inspiration commonly associated with innovators is by this definition the fact of knowledge about a subject changing at an obviously increased rate. Less obvious is when an engineer designs a mechanism or when a surgeon performs a medical procedure; they are innovating at an increased awareness in applying their knowledge to a unique situation thereby accumulating experiential context.

The method and system of an Innovation Bank in the context of an Innovation Economy argues that each increment of new knowledge that makes up the sum of an invention is, in fact, a tangible entity.

Each new idea is based on a prior idea or manifestation of prior inventions within the experiential context of the individual, work group, or network of knowledge participants. It is described herein how interactions are combined in parallel, in series, multiplied, and nested in what may be generally described as a neural network. In order to capture knowledge and wisdom from a network in a tangible form, an accounting system and apparatus is identified which operates at the neural level of the transaction rather than the end point, say, the associated Wall Street stock price valuation.

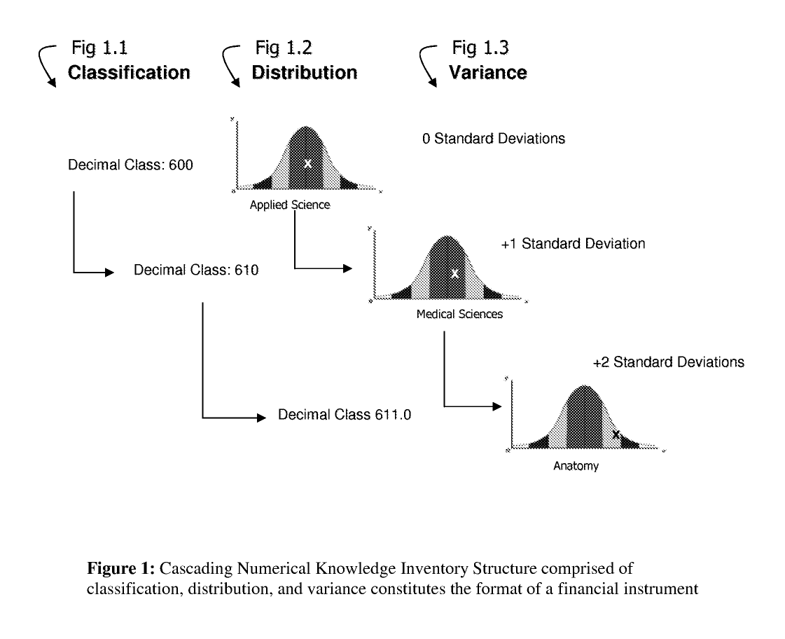

FIG. 1 demonstrates a specific example for a cascading Numerical Knowledge Inventory Structure in the classification, distribution, and variance constituting a format definitive of a financial instrument.

Whereas FIG. 1.1 demonstrates a classification element, in this case corresponding to a UDC where the category of Applied Sciences and is labeled “600”.

Prior art credited to Universal Decimal Classification Consortia; UDC is a known strategy for classification of knowledge employed herein. The arrangement is based on the decimal system. Each number is thought of as a decimal fraction with the initial point omitted, and this determines the filing order. However, for ease of reading, it is usually punctuated after every third digit.

For Example, after 61 ‘Medical sciences’ come the subdivisions 61 1 to 61 9; under 61 1 ‘Anatomy’ come its subdivisions 61 1.1 to 61 1.9; under 61 1.1 come all of its subdivisions before 611.2 occurs, and so on; after 619 comes 62. An advantage of this system is that it is infinitely extensible, and when new subdivisions are introduced, they need not disturb the existing allocation of numbers.

The known UDC has an important feature this is essential to the knowledge inventory formation required by an Innovation Bank. The UDC system is comprised of a means to express not just simple subjects but also relations between subjects. This facility is added to a hierarchic structure, in which knowledge is divided into ten classes, then each class is subdivided into its logical parts, each subdivision is further subdivided, and so on. The more detailed the subdivision, the longer the number that represents it. This is made possible by the decimal notation.

The known UDG is divided into ten main categories:

0: Generalities. Informatics and Information Sciences

1: Philosophy. Psychology

2: Religion. Theology

3: Social Sciences. Statistics. Politics. Government. Economics. Law. Administration. Military. Folklore

4: Unassigned

5: Natural Sciences. Mathematics

6: Applied Sciences. Medicine. Technology

7: The Arts. Recreation. Entertainment. Music. Sports

8: Languages. Linguistics. Literature

91: Geography

92: (Auto-) Biography

93/99: History. Archeology

The known UDG utilizes symbols to as a means of associating subjects. For example:

(+) addition; e.g. 59±636 Zoology and animal breeding

(/) Extension; e.g. 592/599 Systematic zoology (everything from 592 to 599 inclusive)

(:) Relation; e.g. 17:7 Relation of ethics to art

[ ] Algebraic sub grouping; e.g. 31:[622±669](485) statistics of mining and metallurgy in Sweden

(=) Language; e.g. =20 in English; 59=20 Zoology, in English

The design of the UDC lends itself to machine readability specifically as a computer enabled device as would constitute an element of the problem solving space. This is an essential characteristic of the UDG which makes it applicable to the innovation banking system as described in these specifications and drawings. There is no claim on the functionality of the UDC intended or implied herein.

Whereas FIG. 1.2 represents the distribution of knowledge in a population; shown here in a normal distribution, however a binomial distribution may be better representative (many other statistical distributions exist and may be alternately applied to the phenomena described as needed). If a random sample of people is examined for their knowledge in a particular top level UDC schedule, it is likely that a binomial distribution would form around a given classification. If a random sample of persons from a non-random group of practitioners skilled in a UDC schedule were examined for their knowledge in a specialty of that top level UDC, it is likely that a binomial distribution would form around UDC schedules of a set of specialties, and so on.

Whereas FIG. 1.3 demonstrates a recorded variance for members in a population who would occupy a knowledge space in an experiment of knowledge classification expressed as a deviation from the norm. The standard deviation is correlated to the probability that an individual, organization, or society would have sufficient knowledge required to execute a business plan. Such vetting of variance placement is conducted as described in future paragraphs by Community of Practice skilled in the a specified.

The knowledge inventory as required by a method and system of the innovation bank is defined as the UDC for the knowledge embodied within a person, community, or organization plus a correlation to the probability that the knowledge is sufficient to execute a business plan.

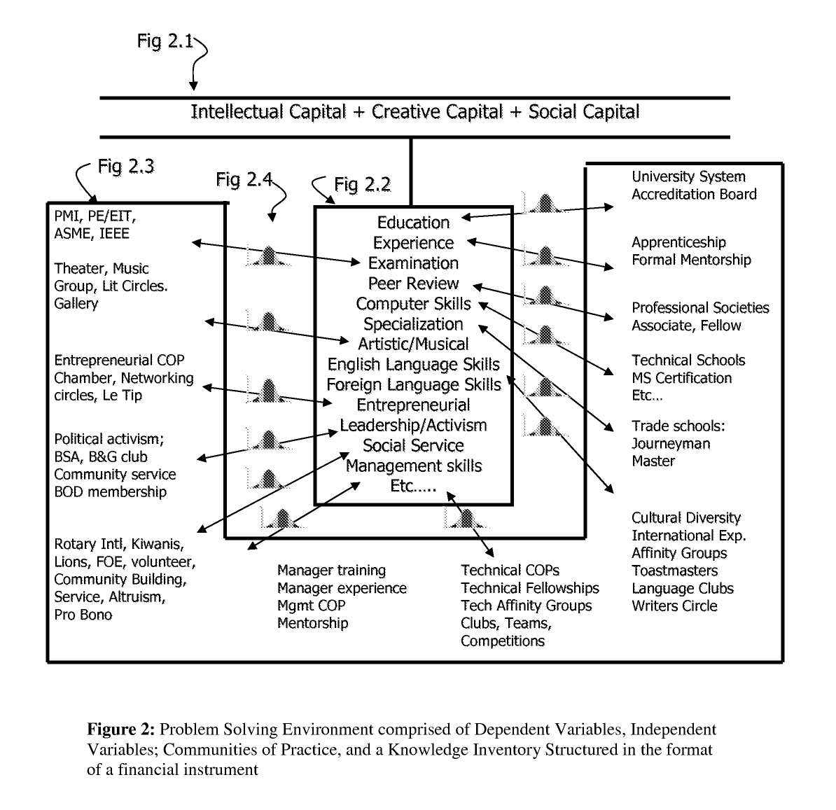

FIG. 2 represents a Problem Solving Environment comprised of Dependent Variables, sample Independent Variables, sample Communities of Practice, and a Knowledge Inventory Structure as specified in FIG. 1. These components, assembled in this form, provide sufficient and necessary data for the employment of mathematical methods associated with financial and economic analysis to be applied to knowledge assets.

Whereas FIG. 2.1 represents dependent variables herein described as families of knowledge that collectively generate the financial value embodied in human innovation as referenced in prior art outlined below; specifically, Intellectual Capital, Social Capital, and Creative Capital further defined from prior art as follows:

Dominating Theories of Innovation:

The three dominating theories of Innovation are known and put forth by established researchers in the field to explain and predict innovation phenomena such as Silicon Valley, Boston's route 128, and the fact of Hollywood, Calif. A dominant objective in regional economic development would be to duplicate the combination of events that led to the level of wealth creation as demonstrated by Silicon Valley, et al.

The Intellectual/Human Capital model can be credited to Jane Jacobs who was ignored for many years until the last few decades. The Human Capital model argues that the key to regional growth lies not in reducing the cost of doing business, but in endowments of highly educated and productive people. Furthermore, clusters of knowledgeable people attract companies that employ them and the investors that put money into them, etc. This is often referred to as the Jane Jacobs Externality.

Social Capital Model has been put forward Robert Putnam out of Harvard. The idea is that communities interact in complex ways. Communities of knowledge consist of people congregating and acting together to improve their communities. Many of the diversity theories come from the Social Capital Model. Bob Putnam sites many examples where communities came together to accomplish what Governments could not accomplished in building economic growth. The Social Capital Model is clearly valid where its elements correlate with economic growth. However, “Group Think” is sometimes blamed for missing new opportunities.

Creative Capital Theory is proposed by Richard Florida of Carnegie Mellon. He posits, for example, that engineers think more like artists and musicians than production workers. As such there is a creative class of people that correlate to a “Bohemian Index—or funkiness”. Such correlation to the environment supposedly helps explain eccentricity associated with personalities of recent generations of technological leaders.

Each of the above cases may be expressed as dependent variables and their descriptive components described in terms of independent variables. The degree in which independent variables correlate to the dependent variables, and among themselves, is the essential analysis dynamic of the knowledge inventory.

Whereas FIG. 2.2 identifies sample independent variables that may be correlated with any one or more of the dependent variables of the three knowledge families.

Whereas FIG. 2.3 identifies sample Communities of Practice that may exist in society whose activities may be correlated to the Independent variables of FIG. 2.2.

Whereas FIG. 2.4 represents the knowledge inventory structured in the format of a financial instrument.

Unit Business Method

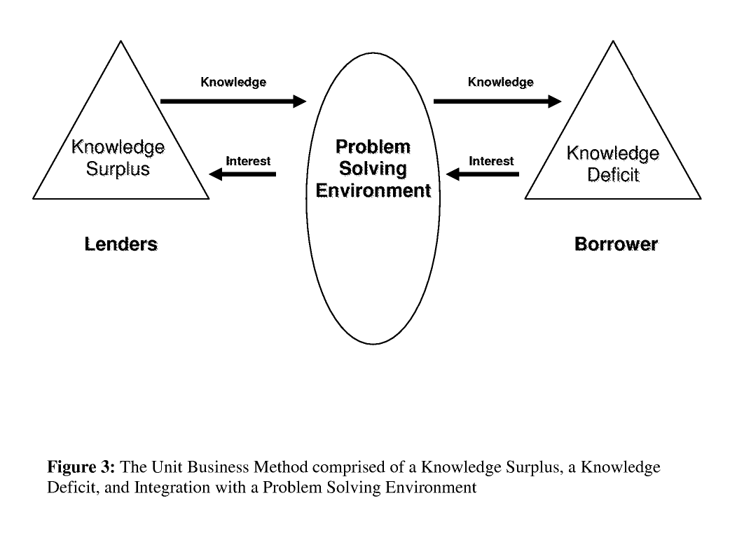

The Unit Business Method (UBM) represented in FIG. 3 is an elemental component of the Innovation Bank is comprised of a Knowledge Inventory Surplus, a Knowledge Inventory Deficit, and Integration with a Problem Solving Environment.

This invention utilizes a simple Unit Business Method—the smallest component of a larger system of enterprise—which captures incremental transactions of the knowledge flows integral to a rate of change of knowledge, herein defined as innovation. The objective of the unit business method is to match a worthy incremental knowledge surplus with a worthy incremental knowledge deficit in a recordable transaction from which generalized transactions may be extrapolated, valued, and traded.

Characteristics of the Unit Business Method (UBM) allow for output of one UBM to provide input to another UBM. The stacking of UBM either in series or in parallel creates nodes of knowledge transfer. The transfer of knowledge across the nodes creates new knowledge. The rate at which knowledge changes will constitutes a metric of innovation.

FIG. 3 demonstrates a graphical representation of the exchange between knowledge surplus and knowledge deficit. Triangles represent inventories of knowledge and the oval represents the Problem Solving Environment. The calculation space is the collector for Universal Decimal Classification taxonomy and associated distributions. The Problem Solving Environment is the domain where the entrepreneur derives correlations and associations utilizing statistical methods and economic analysis tools, etc.

The Problem Solving Environment enables the entrepreneur to identify knowledge surpluses and deficits with improved precision. Entrepreneurial motivation and insight will build transactions that match most worthy knowledge surplus with most worthy knowledge deficit. Interest returns may be in the form of money; however, it may also include access to new knowledge created as a result of injecting diverse knowledge into a unique knowledge inventory. For example; strategic partnerships have the effect of mixing diverse knowledge inventories.

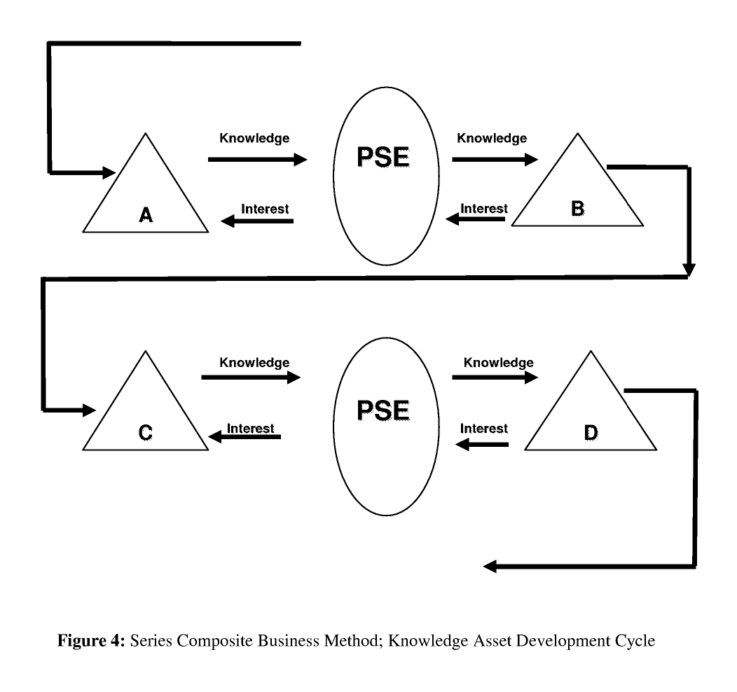

FIG. 4 demonstrates the combination of two Unit Business Methods into a series circuit and is termed herein as a series construct Composite Business Method (SCBM). In the beginning, none of the knowledge inventories are either surplus or deficit inventories. Upon analysis by the PSE, it is revealed that Knowledge Inventory B holds a deficit of a certain knowledge asset required to optimize the probability of executing a given business plan. The PSE further identifies a surplus of the required knowledge in Knowledge Inventory A. The transaction takes place and new knowledge is created within B as a consequence of combining elements of A with B. Knowledge Inventory B is now identified as Knowledge Inventory C. Knowledge Inventory A retains the principle knowledge asset and holds an “interest” in future transactions conducted by Knowledge inventory C. Said Interest may include a financial payment or an option to transact as a deficit with Knowledge Inventory C at sometime in the future, etc. The PSE recognizes that C holds a surplus relative to Knowledge Inventory D and a transaction is continued.

This arrangement may model the phenomenon of Product integration where Marketing may need to know engineering specification who in term must understand financial constrains as well as limitations of material strengths from the laboratory and material availability from Global Sourcing. The product is integrated when all Knowledge Inventories have sufficient knowledge of each other to assure a high probability of success for the enterprise.

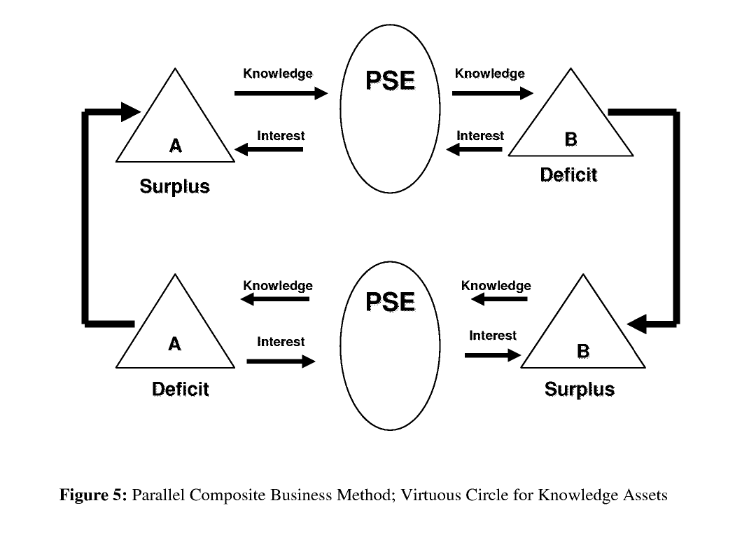

FIG. 5 demonstrates the combination of two Unit Business Methods into a parallel circuit and is termed herein as a parallel construct Composite Business Method (PCBM). In the beginning, none of the knowledge inventories are either surplus or deficit inventories. Upon analysis by the PSE, it is revealed that Knowledge Inventory B holds a deficit of a certain knowledge asset required to optimize the probability of executing a given business plan. The PSE further identifies a surplus of the required knowledge in Knowledge Inventory A. The transaction takes place and new knowledge is created as a consequence of combining elements of A with the totality of B. The Knowledge Inventory B interacts with knowledge injected by A and new knowledge is created in B which is inherently related to A.

The PSE then identifies a knowledge deficit in A where a surplus is held by B and each swap roles; B becomes surplus and A becomes deficit. Knowledge Inventory A immediately exercises an option to access the new knowledge. Once injected, the roles swap again.

This type of transaction may resemble the “Brain Storming” session between two non-competing persons who engage each other in an intellectual manner adding to each other's statement in what is called a virtuous circle of mutual benefit. The virtuous circle applies also to enterprise, societies, and organizations.

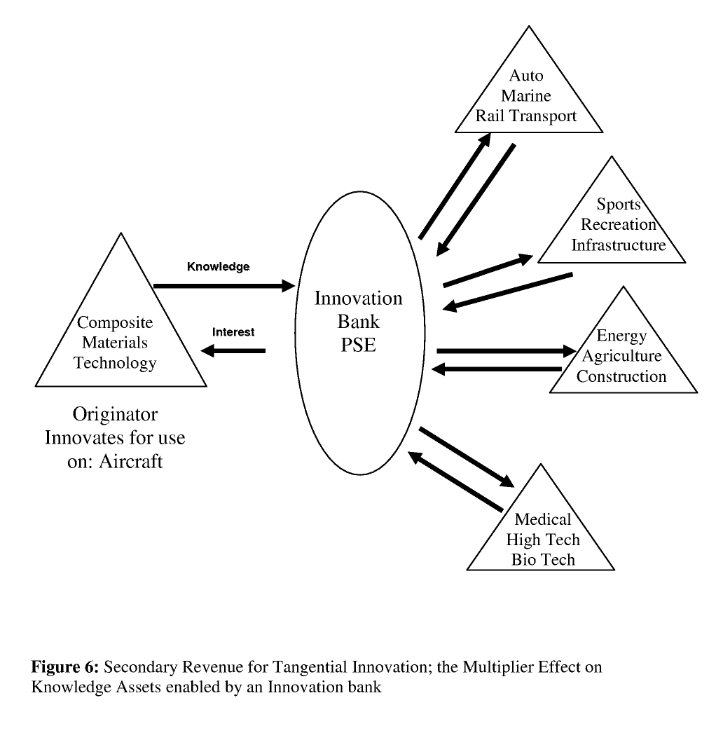

FIG. 6 demonstrates a sample embodiment of series and parallel constructs of the Unit Business Method termed the ‘multiplier effect’ due to a similar effect in Finance where a bank may lend more money than it actually holds in reserve as long as reserves are sufficient to service the draw. In this example, Composite Materials are developed by an aircraft manufacture due to light weight, high strength, and corrosion resistance—the aircraft manufacturer has neither the will nor the resources to apply their knowledge in tangential industries, therefore a non-competitive condition exists relative to other industries.

Eventually, the technology will leak into other industries un-assisted and uncompensated. However, the PSE would actively identify the worthy surplus of knowledge in the Aerospace Industry and the worthy deficit of knowledge in several industry clusters. Entrepreneurs will utilize this invention to induce transactions. As new knowledge forms, deficit knowledge inventories become surplus knowledge inventories as they continue to develop applications of Composite Materials. The originator maintains an option interest in future development from many industries and companies. The net effect for the originator is a multiplier effect on their Research and Development. The net effect for the debtors is innovation (high rates of change of knowledge) and valuable strategic options.

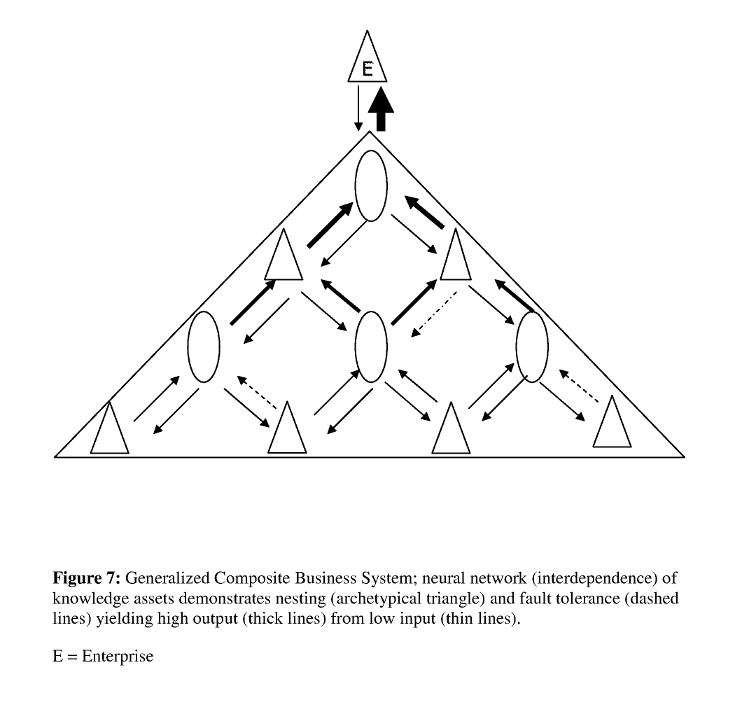

FIG. 7 demonstrates an embodiment of a generalized Composite Business System acting in an enterprise, society, or an organization simulating a neural network (interdependence) of knowledge assets demonstrates nesting (archetypical triangle) and fault tolerance (dashed lines) yielding high output (thick lines) from low input (thin lines).

Further, the act of injecting new knowledge into a system induces innovation as each element interacts with each other. The loss of one sub-knowledge inventory would not necessarily collapse the system; instead, knowledge would reallocated or be drawn from organizational wisdom until the deficit is filled.

The resulting effect is that of a neural network consisting of interconnected processing elements that work together to produce an output function. The output for the network relies on the cooperation of the individual knowledge inventories (people, societies, organization) within the network. Processing of information is done in parallel rather than in series. Since it relies on its member neurons collectively to perform its function, a unique property of a neural network is that it can still perform its overall function even if some of the neurons are not functioning. That is, they are very robust to error or failure (i.e., fault tolerant).

Reconciliation

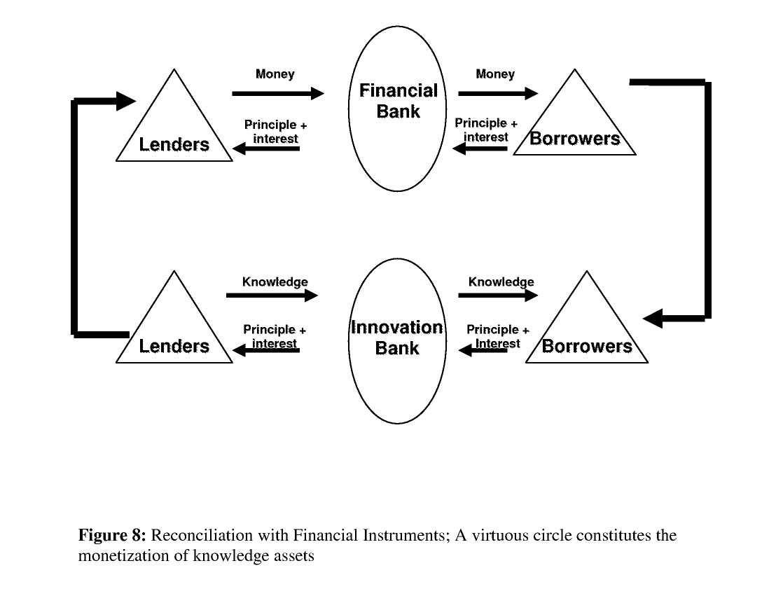

At some point, it is required to reconcile innovation banking with Financial Banking. FIG. 8 demonstrates the mutually serving relationship between innovation economics and financial economics. In is known that regarding a financial bank, the entrepreneur assumes that they possess the knowledge required to execute a business plan, and they utilize a financial bank to borrow the money required to implement the enterprise. The credit scoring system calculates the odds that the bank will realize the expected return on their investment and an adjusted cost of money (interest rate) is determined from the probability calculation.

It is novel that, related to an innovation bank, the entrepreneur assumes that have the money to execute a business plan and they go to the innovation bank to borrow the knowledge. The methods, data, and analysis tools combined with proprietary weighting of variables are used to calculate the probability that the innovation bank (not unlike the credit score) will provide an expected return on their investment of knowledge—the adjusted cost of knowledge may then be calculated from this determination.

For a reconciliation of these two models, the entrepreneur has both the knowledge and the money required to execute the business plan. By extension, the more knowledge that the entrepreneur possesses, the more money they can borrow and the more money they have the more knowledge they can borrow. A virtuous circle forms when each institution recognizes that it is in their best interest that the other exists and performs useful functions. The condition of most worthy surplus matches to most worthy deficit is the dominant strategy of each interacting with the other. Checks and balances between these institutions reward high integrity and punish low integrity.

With the innovation bank and the financial bank in a mutual serving equilibrium, there will become less financial reward for the trade outside of this banking circuit. As such, a self regulating system emerges for protecting intellectual property rights at the sub-patent level.

This is an improvement over current intellectual property protection methods. Currently, legal resources are required to protect and police intellectual property trade. While large scale innovation is made tangible through the application of patents and contracts for use of patents, a great deal of innovation that occurs on the sub-patent scale may return respectable value where an Innovation Banking Institution was operational.

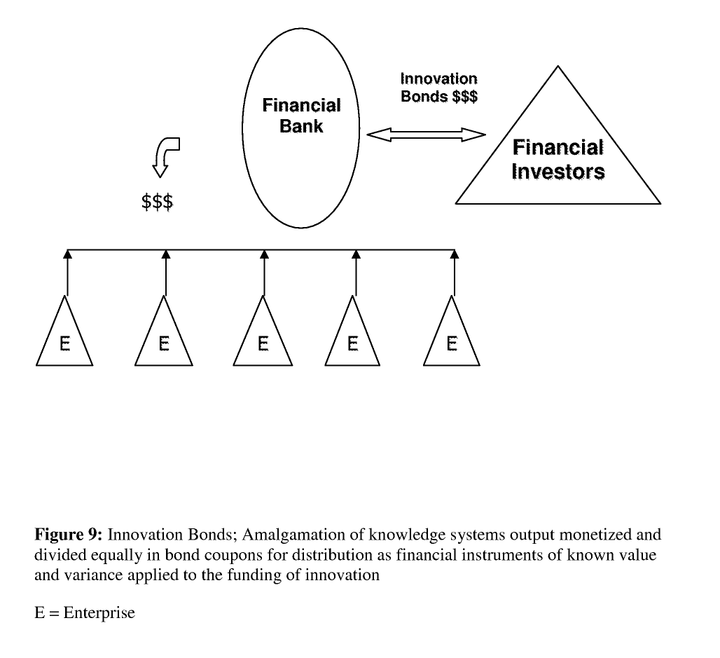

FIG. 9 demonstrates an increasingly generalizes embodiment of the invention where knowledge tangibility results as a consequence of reconciliation with financial institutions. Given the convertibility between the Innovation Bank Assets and Financial Bank Assets, the amalgamation of diversified cash flows may now be segmented into equal parts, formed as “Innovation Bonds” of predictable risk and predictable return. Innovation bonds may then be sold on the global markets to finance important technologies such as aircraft programs, renewable energy, environmental protection, medical research, fuel cells, nuclear fusion, and superconductivity.

The predictability of future knowledge flows and resultant cash flows associated with combinations of knowledge assets and the existence of diversification strategies such as tangential innovation/secondary innovation markets, etc., substantially reduces risk associated with innovation finance. By building combinations of innovation enterprises consisting of promising technology, tangential innovation potential, and non-competitive innovation sharing potential, a low risk/high yield portfolio may be constructed. The net predicted cash flow may be divided into coupons and sold on the innovation Bond market in order to finance the innovation industries.

The amalgamation of these stacked Unit Business Methods constitutes a Composite Business Method and associated enterprise of innovation economics. Stacking of unit business methods in infinite combinations of Composite Business Method structures may themselves become proprietary or patented structures. This stacking features leads to the creation of unique, novel, and non-obvious Business Methods under a new branch of social science herein termed Innovation Economics. The combination of sequential and parallel compositions of the unit business method creates a number of enterprise solutions noted as preferred embodiments.

### Further Embodiments

### Embodiments Related to the discipline of Knowledge Management

This invention acts as a system for managing knowledge. The art and science of traditional Knowledge Management (KM) arises normally from the Discipline of Human Resources (HR). This is correct and natural largely due to the fact that knowledge is interpreted by, contained in, and communicated through the resources embodies individually and collectively within the Human Species. An embodiment of this invention is related to the art and science of Knowledge Management with the exception of being formulated from the discipline of finance. This too is natural and presumed correct largely due to the fact that money is ultimately a representation of human productivity. As such, the discipline of Traditional Knowledge Management arising from HR retains a degree of separation from the financial disciplines and therefore suffers shortfalls in its inability to be capitalized as a profession.

Importantly, the discipline of Knowledge Management has established methods and principles for the management of practical knowledge forms. Specific advanced ideas of KM include the concept of Communities of Practice, their formation and implications. An embodiment of the Innovation Bank is to reward advanced functions in Communities of Practice such as the derivative activity of inventory and accreditation of their knowledge practitioners. In doing so, the applicability, efficiency, and funding prospects of traditional KM may be substantially improved.

### Embodiments Related to Funding Knowledge Management Enterprise

This invention increases funding prospects for innovation enterprise. It is an intended embodiment of this invention to integrate knowledge assets with institutions that would act to increase the convertibility of knowledge assets to financial currencies. The fact of money represents, in abstraction, the fact of human productivity. Human productivity is directly correlated to human innovation(s). As such, the fact of innovation is tantamount to the fact of money.

There are vast institutions formed over thousands of years such as banks, insurance companies, stock markets, etc, that are fully integrated by convertible currencies. The institutions currently associated with innovation, while productive in their own right, are largely segmented by non-convertible “currencies”, constrained in many ways by non-convertibility in knowledge accounting and markets. The Innovation Bank increases convertibility of knowledge into value and rewards the highest order utilization of a knowledge inventory.

### Embodiments Related to Matching Knowledge Surplus to Deficits

A Unit Business Method conceptually matches most worthy surplus with most worthy deficit of knowledge assets. An embodiment of this method and system of an Innovation Bank is comprised of provisions for entrepreneurial activity associated with matching of most worthy knowledge surplus to most worthy knowledge deficit. Persons finding that institutions exist to support the accumulation of their knowledge and benefit from the deployment of their knowledge would themselves seek to organize, formalize, and engage in the enterprise of knowledge trade; that is, matching their personal deficits of knowledge with surpluses encountered in society and matching their surplus with deficits encountered in society deriving profits from the trade. Under these conditions the markets for education, mentorship, and communities or practice will prosper. Likewise, the applications and markets for pure innovation and tangential innovation multipliers will also prosper.

### Embodiments Related to Valuation of Knowledge Assets, Transactions, and Options

The Innovation bank is intended to provide better estimates of knowledge parameters for analysis with specific formulation of system components, common, known, and useful economic analysis methods become available to the entrepreneur. An embodiment for a method and system of Innovation Bank is comprised of enabling analysis tools with which the valuation of knowledge assets may be substantially enhanced.

In the current state of the World, innovation, while net-productive, is largely an extension of the knowledge economy and is conducted in relative isolation within universities, corporations, and governments. Integration within society is limited to local association.

The résumé system represents the current inventory system for knowledge assets and is neither standardized nor integrated—an embodiment is therefore an improved résumé that captures knowledge most precisely. Additionally, political boundaries tend to limit the movement of worldwide knowledge inventories and resulting in a tacit tariff on the trade of knowledge assets.

Embodiments of this invention will improve valuation for knowledge assets. Net Present Value (NPV), Discounted Cash Flow (DCF), Capital Asset Pricing Models (CAPM) are the gatekeepers of innovation enterprise despite the inability of these techniques to assess dynamic nature, follow-on opportunities, options, strategies, and tangential (surplus) knowledge creation.

Embodiments of this invention will improve transactions for knowledge assets. In the absence of a knowledge inventory, rudimental supply and demand curves cannot be established in real-time. By extension; sophisticated techniques for valuation of financial instruments such as Black-Scholes, and Cobb-Douglas, Monte Carlo, et al, are restricted from use on knowledge assets due to the lack of standardized inventory, insufficient estimations of volatility, lack of requisite input parameters, etc. The Innovation bank is intended to provide better estimates to make “less-imperfect” these parameters and enable such analysis.

### Embodiments Related to the Balance Sheet for Knowledge Assets

The innovation Bank utilizes an improved balance sheet recording assets and liabilities. An embodiment for a method and system of an Innovation Bank is comprised of provisions for construction of the accounting balance sheet for knowledge assets as a means of enabling entrepreneurial activity in the trade of knowledge assets.

An embodiment of this invention is to identify knowledge assets. Many enterprise organizations employ sophisticated methods to model the inventory of knowledge required to execute a business commitment. However, business commitments constitute a liability on enterprise because they represent an unfulfilled promise to deliver. Therefore, while the liability is sufficiently catalogued, the assets that are expected to fulfill those promises remain without a catalogue.

The knowledge inventory formulated as specified in the context of an Innovation Bank represents the asset that will fulfill the undelivered business commitment, herein identified as the liability. Assets must balance liabilities in order for an organization to avoid a “bankrupt” condition. The Knowledge Inventory is the institution from which the organization(s) draws knowledge resources to be analytically matched to business liabilities on an improved balance sheet.

### Embodiments Related to Supporting Knowledge Inventory Enterprise

An Embodiment of this invention includes a knowledge inventory as an essential and necessary component of the innovation enterprise balance sheet. The construction, organization and application of the knowledge inventory will add value to an Innovation Economy. Where value is added, entrepreneurial activity is present.

An embodiment of this method and system of an Innovation Bank is comprised of economic activity supporting enterprise in the business related to self-sustaining knowledge inventories. The knowledge inventory is formed by a cascading numerical structure transposable to a catalogue system or systems for written knowledge enabled by the Universal Decimal Classification system.

The format of the knowledge inventory includes cascading tiers related to depth of knowledge. The format of the knowledge inventory includes a numerical tag and associative symbols related to subject matter with knowledge sets enabled by the known UDC Consortia. Additionally, the format of the knowledge inventory includes a normalized distribution relative to the population of practitioners. It is an embodiment that written “knowledge” captured in books, processes, and copyrights are transposable to the knowledge inventory.

It is an embodiment of this invention that knowledge quality is identifiable in terms of proficiency of the knowledge practitioner relative to a community of practice. It is a preferred embodiment that knowledge cost is determinable through relative scarcity and rational substitution of knowledge assets in an inventory. The above embodiments create provisions for the underlying calculus of the method and system of an Innovation bank. Each of the above requisite steps will provide opportunities for continued innovation and associated entrepreneurial activity.

### Embodiments Related to a Probabilistic Electronic Résumé System

The probabilistic electronic résumé system is an embodiment of this invention where a knowledge inventory, percentile search engine, and innovation bank together would make the paper and language Résumé obsolete as a primary knowledge inventory descriptor.

Where the written Résumé contains written information, the UDC decimal format of the knowledge inventory of knowledge assets would enable the use of computers to mine for both surplus and deficit knowledge assets relative to both the business plan and current team of knowledge assets under contract. Text only Résumé is therefore inferior due to subjectivity, semantic inconsistency, and the time and resources required for fully interpreting the content. One major problem in the human resources profession is that the cost of delivering a résumé has been decreased by computers and the Internet while the cost of reviewing the résumé has remained constant.

Further, an enterprise would be able to identify levels of proficiency commensurate with a work statement at the appropriate cost. The innovation bank would then match the deficit with the surplus. Experience gained would be added to the knowledge inventory to enhance the probabilistic résumé inventory available to continued or tangential innovation enterprise.

### Embodiments Related to Supporting External Enterprise for Communities of Practice

An embodiment of this method and system of an Innovation Bank is comprised of a business method that supports the enterprise of joining, operating, and developing Communities of Practice.

The Community of Practice carries out one of the most important functions of the Innovation Bank; to act in the business related to governing institutions for the management, organization, and formation of knowledge as financial assets. Many communities of practice exist today in a variety of forms and functions including that which is prescribed in this invention. Some institutions currently exist as chartered communities of practice, fellowships, service organizations, affinity groups, professional societies, as well as schools and universities, etc.

These organizations exist for the intrinsic value that they provide for the memberships and the natural tendency for people to congregate around common affinity and for the exchange of knowledge. Prior art cites several patents designed to facilitate social interaction of Communities of Practice. However, embodied in this invention, an Innovation Economy is built upon the cataloguing, normalizing, and accrediting a body of knowledge. Communities of Practice become economically feasible in their own right and financially useful to the entrepreneurial activity relative to innovation enterprise.

As such, Communities of Practice may command a financial reward for their effective operations in the business community (usage fee) and the practitioner community (membership fee). Directors of the Community of Practice and the membership related by knowledge attributes may engage in enterprise as a result of effective governance of the Community. Should a community of Practice act inefficiently or provide knowledge that is irrelevant to a market, they will be replaced in competition from other Communities. Under these conditions, it is assured that most worthy knowledge surpluses are produced and valued properly through fair market forces of supply and demand.

### Embodiments Supporting Nested Enterprise for Communities of Practice (COP)

The Innovation Bank provides revenue to Communities of Practice which in turn provides revenues to supporting institutions. A preferred embodiment of this method and system of an Innovation Bank is comprised of provisions to support enterprise in the business related to Communities of Practice whose factors of production include the classification, normalization and accreditation of knowledge attributes within the scope of the practice. Further activities include business practices for the dissemination, distribution, and development knowledge assets within the practice and subsequent active and passive accreditation of related practitioners.

The degree to which Communities of Practice production adds value to the Innovation Banking Enterprise determines allowable margins on revenues derived from subscriptions, accreditations, web portals, targeted advertising, and other revenue streams. Each of these business functions requires specialists ostensibly belonging to another Communities of Practice—Each participant acting in their best competitive self interest will seek to match most worthy surplus to most worthy deficit. Over time, the activity becomes more precise as niches are filled by entrepreneurial activity. An embodiment is that the Innovation Bank, in effect, builds itself.

### Embodiments Related to Fair Markets for Enterprise for Communities of Practice

The Innovation Bank induces efficient markets for knowledge assets where Communities of Practice are influenced by market forces, not unlike any financial instrument. A preferred embodiment of this method and system of an Innovation Bank is comprised of business related to a sustaining market for Communities of Practice where events of cooperation and competition increase the efficiency and viability of a market for accreditations, internal governance, high integrity, and all associated services related to the enterprise of knowledge inventory management in the context of innovation markets.

The market forces acting on individuals, likewise act on collections of individuals in a Community of Practice. As a result, it is assured that most worthy knowledge surplus finds most worthy deficit and is properly valued through fair market forces. A Community of Practice that fails to generate revenue through value added services either by the presence of competition, inefficiency, obsolescence, or irrelevance in a market will cease to exist or will merge/divest knowledge assets. Likewise, a CoP that is too successful will spin off competitors. The market for knowledge assets becomes more efficient and fairly priced.

### Embodiments Related to Supporting Complete Markets for Innovation Enterprise

The Innovation Bank supports complete and fair information relating knowledge markets. An embodiment of this method and system of an Innovation Bank is comprised of provisions for enterprise related to self-sustaining knowledge inventories for components associated with Innovation Enterprise; generally identified herein as knowledge families: Intellectual Capital, Social Capital, and Creative Capital—and tangentially, Strategic Capital.

The components that constitute a complete market are most likely to reveal complete information to a market. Where information is complete, arbitrage opportunities diminish. Further, it is unlikely that one individual or one Community of Practice would dominate all tangible elements in a knowledge inventory at the complete spectrum, however, for example; three, ten or forty persons, each highly developed in one or more components and acting in their best collective interest within an innovation banking enterprise would simulate a complete market.

Additionally, since no one person or Community of Practice can dominate the full spectrum of knowledge and, acting in their best interest in an Innovation Banking enterprise, would be drawn to inventory corresponding to their personal interests and strengths. A practitioner's dominant strategy therefore does not favor competing in an area too far outside of ones natural abilities. In aggregate, a complete inventory representing complete spectrum of human capability will manifest. The highest self-actualization of the human becomes a natural effect of the market dynamics generally correlated to professional satisfaction; a powerful force for productivity.

### Embodiments Related to Supporting the Public PSE for Statistical Analysis

The Innovation Bank promotes high level analysis and ownership of knowledge assets. An embodiment of this method and system of an Innovation Bank is comprised of entrepreneurial activity in the application of specific economic and econometric methods of analysis for knowledge assets in an innovation enterprise within the context of a non-claimed Problem Solving Environment. Multiple regression analysis may analyze independent variables for a given dependent variable. A dependent variable of “Social Capital” may correlate within an enterprise to independent variables of, say, public speaking skills, business etiquette skills, Golf score, and leadership experience. Likewise, Creative Capital may correlate with; musical abilities, patents and publications, and Miller Analogy test score. Finally, Intellectual Capital may correlate with; years education, books read, mathematical proofs, academic scores, etc.

By extension, the analysis and weighting of independent variables may comprise an entrepreneur's trade secret for a successful sales campaign, strategic product development, or Unit Business Method construct. The output of the percentile search engine will yield probability estimates for use in scenario testing, hypothesis formulation, dominant strategy assessment for utilization of knowledge asset resources. Empirical feedback and lessons learned return to the system through modifications to prior assumptions regarding independent variables and weighting in, say, a proprietary algorithm. A proprietary algorithm simulates enterprise wisdom for which protection, development and ownership is rewarded in the market.

### Embodiments Related to Supporting Public Problem Solving Environments (PSE)

The Innovation Bank supports a market for knowledge assets by providing parameters in a format that may be treated with common analysis tools. This capability comprises of a Problem Solving Environment representing the nodes of a business plan where entrepreneurs utilize their knowledge and creativity to invent new ways of combining knowledge. An embodiment of this method and system of an Innovation Bank is for enterprise associated with the analysis of parameters where those most successful at analyzing data are rewarded by the market.

While the Problem Solving Environment remains in the public domain, the expertise developed by the entrepreneur becomes proprietary on the order of a trade secret. Eventually, the algorithm proprietary to a successful entrepreneur may become marketable on a consulting fee or subscription basis. For example, one may wish to look through the filters of the Boeing Algorithm or Disney Algorithm or compare their own weighted assessment to that of another person on a team. When a long time employee retires, an algorithm related to their expertise may remain with the employer or enter the public domain.

### Embodiments Related to Proprietary Problem Solving Environments (PSE)

The Percentile Search Engine is the embodiment of a condition that is generally synonymous with the Problem Solving Environment with the exception of referring to a proprietary weighting scheme. The Percentile Search Engine is comprised of all mathematical, interpretive, or formulated renderings of data produced to the Problem Solving Environment whose parameters are weighted by an individual or group based on experience and tribal knowledge.

For example; a Boeing algorithm may give a higher weight to technical analytical parameters while the Disney algorithm would favor creative analytical parameters—yet both require engineering talent. The output of the Percentile Search Engine would generally be in the form of an expression of probability, qualification and quantification and utilized in predictive analysis; or as the difference in value between two or more options or contingencies.

### Embodiments Related to Supporting PSE in Game Theory

An embodiment of the Innovation Bank supports a market for knowledge assets through application of advanced economic methods. Game theory is a complex branch of economics that is used to predict and influence human behavior due to economic pressures. John Nash shared the Nobel Prize in economics for his work in Game Theory. This tool depends upon the ability to predict the probability that an individual or organization will select a particular dominant strategy (One cannot make a bet without odds). Game theory is recognized for the ability to influence human behavior under the assumption that most people and organizations act in their best own perceived best interest.

Although there are many classified “games” one example may be demonstrated with the prisoner's dilemma. The dilemma is presented due to imperfect information between the two offenders and the police who lack specific evidence. Each player must estimate the probability that the other will act in a certain manner in order to make a move. Business situations mimic this and many other types of games where imperfect information leads to imperfect behavior especially when exercising options, mergers, acquisitions, and competitive enterprise.

### Embodiments Related to Supporting PSE in Fair Competition

Within an embodiment of the innovation bank, competitors would want to know if their competition has the knowledge inventory required to compete with a certain new product. Companies would need to know the probability that they will be able to accumulate sufficient knowledge given a play on a certain discipline. Knowledge workers need to estimate the probability that a new technology requires their skill set given what others knowledge workers do. The method and system of Innovation Banking utilizing a Problem Solving Environment and proprietary Percentile Search Engines as the space for resolving economic dilemma.

An embodiment of this invention includes a condition where probabilities may be assigned to business strategy in a knowledge economy; the utility of a Percentile Search Engine is apparent. With the ownership and capitalization of knowledge space, people and organizations will act to preserve the integrity and value of knowledge space. This self-regulating characteristic of game theory would now apply to the economies of Innovation as it currently applies to economies of finance.

### Embodiments Related to Supporting PSE in Econometrics

Econometrics: Cobb-Douglas production functions are used to determine contribution of particular Independent variables on a given dependent variable. Econometrics depends a great deal upon probabilities, averages, and standard deviations. As such, the utility of a Percentile Search Engine is apparent.

### Embodiments Related to Enterprise in Innovation Insurance

An embodiment related to the ability to identify risk exposures, calculate probability that an identified risk will manifest and the ability to value the consequences, satisfies a risk model for insurance. As such, an embodiment of the Innovation Bank consists of provisions for enterprise in the insurance of innovation investments. The Innovation bank and its constructs provide rational estimates to each of these conditions and therefore satisfy the risk model for insurability. Where risk is eliminated (or greatly reduced) capitalization is greatly increased.

### Embodiments Related to Supporting Risk Exposure Pooling

An embodiment of this method and system of an Innovation Bank is comprised of provisions for Risk Exposure Pooling for knowledge assets. Actuarial science depends on the accuracy of the statistical methods of risk exposure pooling. This method collects similar risk exposures into risk sharing cooperatives. Insurance could not price policies correctly if low risk exposures over-subsidizing high risk exposures. As such, the utility of a percentile search engine in the context of the Unit Business Method is substantial.

Risk is defined as a variation of expectation and may either be a positive (higher than expected profit) or a negative (lower than expected quality). Strategies for pooling risks are important for diversifying away negative risks as well as collecting synergies among positive risks for the purpose of optimized asset allocation. These important pooling strategies of actuarial sciences would now apply to the economies of Innovation as they currently apply to economies of Finance.

### Embodiments Related to Supporting Diversification of Knowledge Assets

An embodiment of this method and system of an Innovation Bank is comprised of provisions for Diversification: Risk exposure diversification is an important where one risk exposure is isolated from other risk exposures as a means of limiting looses. In order to utilize this method, the probability that one independent variable is inversely correlated to another must be known. We must have normalized data in order to determine inverse correlation. As such, the utility of a percentile search engine is apparent.

### Embodiments Related to Amalgamation of Predicted Future Cash Flow of Diversified Knowledge Assets

An embodiment of this method and system of an Innovation Bank is comprised of provisions for enterprise in the packaging of Innovation Bonds. A collection, construct, or of Composite Business Method structures of predictable future cash flows may be grouped in a diversified portfolio whose amalgamated cash flow may be divided into Innovation Bonds and sold to investors for the purpose of raising capital for Innovation Enterprise.

Currently, Venture Capital seeks returns of 800-3000% in order to compensate for high risk on investments with a high threshold often in the millions of dollars. The preferred embodiment of this invention would enable a far greater number of investments that may produce yields between the cost of money and the markets served by Venture Capital, i.e., the 20%-90°% return range. This market would be adequately served by collections of investors willing to accept returns in this range on a smaller note. Innovation bonds in a diversified portfolio of pooled risk exposures would enable greater prospects and more secure prospects for venture investment at substantial returns.

### Embodiments Related to Tangential Innovation Markets

An embodiment of this method and system of an Innovation Bank is comprised of provisions for enterprise in Tangential Innovation Application for multiple uses of a similar knowledge set in cooperation by non-competing enterprises as a means of diversifying knowledge assets while realizing economies of scale in human capital, social capital, and creative capital.

An entrepreneur may be able to calculate the NPV return on a primary investment in knowledge assets to justify expenditure. However, a tangential innovation plan would identify secondary and tertiary markets in diverse industries for resulting knowledge assets. As such, an invention that increases durability of a machine in one industry may reduce costs in another industry. The net present value accounting for tangential innovation would be substantially different that without tangential innovation.

### Embodiments Related to Human Resource Utilization and the Banking of Knowledge Assets

An embodiment of a method and system of an Innovation Bank is comprised of provisions to “Banking” Knowledge Assets. The Savings Account for Intellectual Capital is a novel device for preserving intellectual capital in a cyclic industry. Where a downturn would generally require the mass layoff of experienced knowledge workers, the existence of local tangential innovation industry where non-competing industries cluster around a common technology would provide alternate employment for knowledge workers in an innovation enterprise. Transferring workers allows for the continuation in development of knowledge assets, analogous to interest paid on a savings account.

During a cyclic economic downturn, knowledge workers would transfer into a diversified tangential innovation industry. For example; composite technology engineers from aerospace may easily transfer into composite technologies for automotive or recreational equipment until economic cycles reverse. In the absence of knowledge inventory and tangential industry large scale layoffs—a practice largely defining the cyclic aerospace industry of which this author was a participant—destroys value in lost knowledge assets and generalized fear and resentment in a workforce. Creative artists would transfer from Production Company to Production Company—a practice largely defining Hollywood Entertainment industry of which this author was a participant.

### Embodiments Related to Supporting Assessment of Contingency Claims

An embodiment of the method and system of an Innovation Bank is comprised of provisions for enterprise in financial instruments whose variations are too numerous to list or predict herein. However, a less intuitive example may demonstrate the variety and potential in the creation of financial instruments enabled by the method and system of an Innovation Bank. Example: An Option is defined as the opportunity but not the obligation to act on a future condition. While there are many types of options, what is termed an “American Option” has following components: a premium paid to own the option, a future strike price, and an expiration date (or not), and a volatility estimate. From these parameters the entrepreneur can estimate the tangible “value” in holding an option to act on a contingency for a future set of outcomes.

The method and system of an Innovation Bank provides data from which option parameters may be better estimated, especially the parameter of “volatility”. Volatility is related to variance and may be derived from the knowledge inventory, normalization, and accreditation data as well as various algorithms and enterprises (many noted above) that would be associated with probability of particular outcomes. Finally, where data is imperfect, the difference between the values of two or more options may be highly accurate in terms of a ‘yes’ and ‘no’ decision. The ability to characterize yes and no decision trees facilitate computational approaches and associated enterprise.

### Embodiments Related to Business Plan Formation

An embodiment of the method and system of an Innovation Bank is comprised of provisions for enterprise in business plan formulation. Business plans require assessments of the market, threats to the business strategy, fatal flaws in business plan, and the assembly of management teams and associated workers. The Innovation bank, knowledge inventory, Communities of Practice, acting in an open source Problem Solving Environment enables business plan formation by entrepreneurs who may identifying knowledge inventory of the target market, and/or, the knowledge inventory of the management team, and/or the deficits in knowledge existing in the business venture, the available workforce, and/or a competitor's reactivity. The ability to analyze the volatility, size, breadth, depth, and scope of knowledge attributes, as well as the ability to gain patent protection for unique methods, systems and apparatus for an innovation enterprise would greatly enable formulation of business plans.

Output from the Problem Solving Environment would provide a probability matrix and dominant strategy profiles which spells out probabilities and contingencies in terms of Game theory, Real Options, et al, with a final overall probability of success and standard deviation related to volatility to be expected. Scenario testing is a hallmark of successful business case analysis.

### Embodiments Related to Management Team Selection

A preferred embodiment of this method and system of an Innovation Bank is comprised of provisions to Management Team selection. Output from the Problem Solving Environment from the Innovation bank may produce a list of, say, 5 persons who have never met but perhaps are living within a 10 mile radius that calculate to deliver a 86% probability of executing this probability matrix with an expected variance.

The existence of such information will increase the efficiency of management selection and decrease the risk of subjective management of persons and projects. Where a key member of a team were to leave an organization, the knowledge inventory would identify relevant deficits created by the absent team member. Where the team member may not be replaced directly, that may be simulated by the redeployment of knowledge assets from other areas of the organization.

### Embodiments Related to Supporting Competitive Analysis

A preferred embodiment of this method and system of an Innovation Bank is comprised of provisions to Competitive Analysis: A company is hoping to launch a new product. Management sees that the competitor has sufficient in-house knowledge and experience to compete fiercely. The competitor would have a similar access to the first-mover's knowledge inventory. An enterprise may then select an innovation where one would enjoy a knowledge advantage. A competitor may choose to not compete based in the business intelligence available. Markets can be isolated, competition will be calculated and voids will be filled by those organizations most qualified to fill them; specialization is efficient

### Embodiments Related to Supporting Knowledge Ownership and Mentorship

The question arises regarding human ‘free will’ that is the randomness of the human spirit making efforts to conceptualize and predict human behavior suspect of rationality. An embodiment of this method and system of an Innovation Bank is comprised of provisions resulting in autonomous professional accountability. The Percentile Search Engine operating within the Problem Solving Environment would “Ping” practitioners in a knowledge inventory to participate in a particular enterprise action or venture. The quantity and quality of the ping would largely determine the financial compensation to the practitioner.

It is therefore in the best interest of the individual to maintain the clarity and integrity of their personal knowledge assets including but not limited to reputation, professionalism and relevant skill set. The practitioner now acts as an owner, and indeed becomes an owner, of their knowledge inventory. Acting freely, the practitioner will seek to maximize their quantity and quality of pings from the PSE. Where the practitioner is highly successful receiving far too many pings than they can accommodate alone, either competitors will form, or the practitioner will sub-ping to understudy practitioners, thereby preserving the art and knowledge. In time, and not unlike the dynamics of the Unit Business Method, the borrower becomes the lender. An elder practitioner who has trained many understudy practitioners will enjoy sub-Pings from them later in the career.

### Embodiments Related to Supporting Professional Accountability

The Innovation Bank provides a mechanism for professional accountability without the need for legal institutions. The revocability of a driver's license makes erratic driving behavior a very expensive enterprise—as such, the general behavior of drivers largely tends toward responsibility. Likewise, the natural effect of the PSE is to punish unethical behavior, breach of contract, negligence, IP pilfering, incompetence, fraud, etc.

### Embodiments Related to Providing Complete Information to a Public Market

An embodiment of this method and system of an Innovation Bank is comprised of provisions to new risk data points. Stock holders will reward or punish a publicly traded enterprise where the knowledge inventory disclosure statement is perceived to be optimized and balanced. For an enterprise with too many PhDs in a low level technology, an investor may feel that management if paying too much for knowledge assets and punish the stock into a correction.

Likewise where a public company does not exhibit the sufficient or appropriate knowledge assets to execute an ambitious new program, stockholders would punish the stock value for perceived risk. Likewise, the hallmark of good management is the matching of most worthy knowledge surplus with most worthy knowledge deficit and stock price will be rewarded for low risk and high efficiency.

### Embodiments Related to Supporting Economic Development

An embodiment of this method and system of an Innovation Bank is comprised of provisions for enterprise related to Industry Clusters i.e., aerospace clusters, life sciences clusters, information technology clusters, etc. Industry clusters are often referred to as “innovation clusters” and represent a powerful economic growth strategy. Silicon Valley is the archetypical example. Although there are many advantages to industry specific innovation clusters, there are several disadvantages. Industry clusters are sensitive to economic shocks. Industry specific innovation clusters are subject to stagnation as competitive pressures restrict free cross flow of knowledge. Innovation banking solves this problem by inducing non-competing diversified technology specific Innovation clusters.

The methods and systems of an Innovation Bank, through tangential innovation enterprise, enable clustering around a technology such as Composite Materials, Information processing, Fuel Cells, things made from aluminum, etc. Business intelligence relates to the rates that Industry Clusters and Technology clusters would change in relation to each other as well as contingencies associated with rates of adoption of rapidly advancing technologies.

Such a condition absorbs economic shocks among diverse industry, accelerating cross flow among knowledge assets, and supporting high concentrations of important knowledge skills in the same geographical area where knowledge sharing can efficiently take place.

An embodiment of this method and system of an Innovation Bank is comprised of provisions for enterprise in knowledge asset cross pollination. Enterprise within the context of the Innovation bank will systemically cross pollinate practitioners such that innovation clusters will form around diverse enterprises sharing common attributes, preserving diversity in generally non-competing markets. Knowledge flows are experience lesser restrictions and innovation flourishes.

### Embodiments Related to Global Markets

The challenges of the future require global interchange and cooperation especially related to environmental and energy concern, fair trade, and capacity building in impoverished communities. Among the constraints associated with this embodiment are relatively fair financial markets. The existence of such markets in the developed economies would give those economies a low cost position on Global innovation and finance markets.

A preferred embodiment of this method and system of an Innovation Bank is comprised of provisions for enterprise related to on-shoring Innovation. With cheap money funding secondary innovation markets, Innovators from around the world may send tangential innovation to the U.S. for generation of secondary revenue. Given the infrastructure and financing options of innovation in the U.S., the U.S. may become the low cost source for innovation for global transfer and application. Highest value added will produce jobs necessary to fund liabilities such as medical and pensions.

A preferred embodiment of this method and system of an Innovation Bank is comprised of provisions for enterprise in Global Innovation markets in a virtuous circle. As money flows into the innovation sector, the value of independent variables in the knowledge inventory will increase. The accrediting institutions will develop programs and methods that will increase their relevancy to the independent variable pool. The percentile search engine will become increasingly applicable to global knowledge assets. The rate of change of knowledge will increase placing a multiplier effect on innovation.

### Embodiments Related to Supporting Depth to the Internet

An embodiment of this method and system of an Innovation Bank is comprised of provisions for enterprise in the improvement of Internet content and access volume. Currently search parameters return increasingly trivial results as semantics confuse the meaning and intent of the user. The knowledge inventory provides a search taxonomy that would increase the precision of a search for knowledge surplus or deficit. The existence of a means for mining Communities of Practice vastly increases the depth and scope of the Internet. Through the method and system of the Innovation bank—that is matching knowledge deficit with knowledge surplus—much of the Internet would become “assets under management”.

### Embodiments Related to Supporting Improved Marketing

An embodiment of this method and system of an Innovation Bank is comprised of provisions enterprise in targeted Marketing as a means of generating revenue to support the system. Communities of Practice and associated knowledge inventories and classification system may accept targeted advertising as well as targeted conferences and Journals. The ability to enhance demographic accuracy is a revenue source for innovation enterprise. Advertising rates can be priced more accurately relative to the audience.

### Embodiments Related to Supporting Enabling Institutions

While the world of finance enjoys full integration innovation institutions remain largely fragmented. Venture Capital, corporate R&D, and University research and government research only serve the highest quality commercial prospects while discarding a large percentage of ideas and opportunities to the NPV/DCF (net present value/discounted cash flow) graveyard. Subject matter experts are retired; patents go unexercised, tangential innovations are not pursued, non-pedigree intellect is unrecognized.

Therefore an embodiment exists for a business method and system where independent variables associated with success attributes would be embodied by a single entity among individuals combined in a strategic manner to meet or exceed the intellect, creativity, and sociability of, say, the 95% percentile entrepreneur. The component make-up of the combination could be altered, designed, simulated, and augmented either by the inclusion or elimination of a particular attribute in a dynamic and real time environment. Accountability will be assured by a game where all participants acting in their own best interest in fact act in the best interest of the group.

### Embodiments Related to Various Additional Revenue Streams

An embodiment of this method and system of an Innovation Bank is comprised of provisions for varied Revenue Streams: Submission to the Internet will increase in depth and breadth as micro payment technologies improve. The knowledge classification system in conjunction with the Percentile Search Engine will greatly increase the ability to place a value on a knowledge asset. Micro payment revenue models will capture and amalgamate knowledge flows. Data miners will return royalties to the originator of the content. The innovators that create knowledge content will enjoy steady cash flows.

In many less developed countries, power and information is very highly concentrated. An embodiment of the Innovation Bank is to greatly diversify information sources for the purpose of economic development. An embodiment of this method and system of an Innovation Bank is comprised of provisions to Global Innovation Market: Innovation is relative to the level of development of a country. In a less developed country, innovation may constitute the construction of a road that does not wash out during a rainy season. The reduction of corruption risk and the ability to capitalize knowledge assets in a less developed country would attract mainstream investment capital for development of impoverished country.

An embodiment of this method and system of an Innovation Bank is comprised of provisions for International applications—innovation is defined as the rate of change of knowledge. Where knowledge is low, rates of change can be extremely high. Under these conditions created by an Innovation Bank, locations with the greatest difference in development will constitute the greatest opportunity for innovation investments. Broad steps forward in an undeveloped country would yield the greater financial opportunities than is currently possible or may be possible in developed countries with smaller incremental steps. It may become more profitable to develop less-developed countries in a fair and equitable manner than is experienced today. As such, a business case for poverty reduction may be improved.

An embodiment of this method and system of an Innovation Bank is comprised of provisions for Global Application: accountability is assured by the personal ownership of each participating person in their knowledge space. The equations of the Problem Solving Space reward success and punish failure not unlike the credit scoring system or EBay. Persons across the globe have demonstrated their willingness and ability to practice high integrity in Global Markets and carry their own set of knowledge surplus regarding geography, culture, and world politics. Global participation in the innovation across global enterprise is essential and able to plug into an Innovation banking system.

A preferred embodiment of this method and system of an Innovation Bank is comprised of improvements in Global Sourcing. Suppose that an innovation bank were located in the supplier country. An alternate source of local information would compete with controlled information such as political, government, biased media, poor translation/lack of translations, etc. An alternate market for accurate data will emerge in competition with biased media. The resulting business activity will reward high ethics and punish low ethics. The net result is the reduction of risk leading to increased valuation of knowledge assets worldwide and a reduction in salary arbitrage possibilities. Increased fairness in the knowledge asset markets will allow for the efficiencies of true specialization to occur.

A preferred embodiment is related to consolidation of Global Knowledge inventories. The problems that face the world such as Global Warming, Energy Constraint, Poverty, and health matters are far to large and complex for one single nation to manage. Knowledge Practitioners from all nations must be empowered and unified in a fair and integrated financial market independent of political boundaries such that their innovations and transfer of knowledge may be capitalized and traded universally.

### Embodiments Related to Business Intelligence

An embodiment of this method and system of an Innovation Bank is comprised of provisions to Business Intelligence. Like the financial bank would concern itself primarily with the rate of change of money, that is, Interest Rate. The Innovation Banker is concerned with the rate of change of information when assessing Knowledge and the rate of change of knowledge when assessing Innovation. Business Intelligence herein is defined as access to intelligence related to rates of change in components of the Innovation Bank and/or the knowledge inventory.

1. Knowledge Mapping: The knowledge inventory may be surveyed in order to determine if they are a worth the value that the stock market gives them. They may be surveyed to determine sales price, attrition value, merger candidates, or bankrupt of knowledge assets altogether. Further, the rates at which any of these parameters may be changing could be inferred from metrics.

2. Corrections can be made accordingly by favoring a particular attribute in the hiring process or by targeting specific educational programs. Business intelligence may also relate to the rates at which the quantity may change.

3. Enterprise would be able to assess the knowledge inventory of potential competitors in order to determine the probability that they could mount a disruptive attack. Business intelligence also relates to the rates at which the quantity may change and/or the rate at which the attack would ensue.

4. An acquisition of a company would be better valued if the financial value could be placed on the knowledge assets of the organization. The Problem Solving Environment would be able to predict the probability of continued cash flow associated with a knowledge inventory. Business intelligence relates to the rates at which values for cash flow changed with respect to other knowledge asset variables.

5. Enterprise would be able to identify pools of knowledge assets in a given geographic area as a business strategy for relocation or competitive advantage. Business intelligence would relate to the growth rates of the enterprise given access and vicinity of permanent or pre-existing knowledge assets.

6. Enterprise would be able to project availability and cost of knowledge assets against geographical, demographic, sociological factors. Business intelligence relates to the rates at which supply, demand, cost, and quality may be changing individually or in combination given for a set of existing or potential circumstances.

7. Enterprise would be able to design communities of practice in unique proprietary configurations for the purpose of gaining or maintaining competitive advantage. Business intelligence relates to the ability to increase rates of change in information and/or knowledge as a means of gaining competitive advantage or economies of scale in the context of innovation enterprise.

9. Advertisers could target marketing to a specific knowledge demographics within the problem solving environment where Communities of Practice could generate revenues and filters from the corresponding knowledge attributes associated with the sales campaign. Business intelligence relates to the rates at which knowledge assets interface with the COP or the rate at which their needs are related to the knowledge inventory, etc.

### Embodiments Related to Scenario Testing

A preferred embodiment of this method and system of an Innovation Bank is comprised of provisions to Scenario Testing. The Problem Solving Environment collects, processes, searches, and interprets probabilistic data for use by applications such as: The Scientific Method, MRA, Game theory, Econometrics, Six Sigma, resource management, constraint analysis, etc.

Example: Suppose an Innovation entrepreneur has a business plan they want to execute. The percentile search engine will allow the banker to calculate the probability that certain combination of persons living in a particular community possess the knowledge required to execute the business plan.

Example: The entrepreneur would be able to predict that the knowledge possessed by Joe, Mary, Diane, and Robert would have an 87% combined probability of executing the expectations of a particular business plan at a known cost. The removal of Joe would reduce the probability to 84% at a discount of 20%. But with the elimination of Joe and the addition of Stephanie, the probability increases to 92% but will increase the cost by 14%. The PSE is useful because such scenario testing may occur prior to committing to the business plan.

Example: The PSE would determine probabilities for dominant strategies in a Game theory scenario involving Joe, Diane, Mary, and Robert.

Example: The percentile search engine would allow the testing of the relatedness of musical abilities to technical innovation potential of a particular business plan involving Joe, Diane, Mary, and Robert.

Example: The percentile search engine would be able to predict the probability that the secondary innovation market would produce a range of revenues prior to a company initiating the innovation for primary market. In other words, the PSE can impact the initial investment decisions.

The embodiments of the invention in which an exclusive property or privilege is claimed are identified as follows:

1. A method of conducting business for trade in knowledge assets, herein called an Innovation Bank, comprised of a novel formation and interaction of specific system components acting together for the purpose of matching most worthy knowledge surpluses with most worthy knowledge deficits based on the output of analytical tools enabled by this invention and typical of the discipline of finance and economics thus utilized by entrepreneurs within a business model that is analogous to a financial banking system such that proprietary weighting factors applied by an entrepreneur simulates ‘wisdom’ and constitutes a tradable asset wherein the improvement comprises;
a. A means of combining data output from a Knowledge Inventory, categorization of Knowledge Space, assessment of knowledge domains, and vetting by Communities of Practice.
b. A means for utilizing economic analysis tools and statistical principles on data sets associated with knowledge attributes as dependent and independent variables.
c. A means of providing probability of success or failure related to the application of various knowledge assets in the context of a business plan.
d. A means for providing relevance for varied knowledge attributes either favoring or disfavoring the execution of a business plan.
e. A means for associating sets of dependent variables and associated independent variables related to knowledge attributes.
f. A means of matching most worthy knowledge surplus with most worthy knowledge deficit through the repetitive application of a unit business method and associated constructions of same.
g. A means for testing scenarios related to the application of varied knowledge assets for the purpose of diversification, strategic alignment, and workflow stabilization; prior, during, and after deployment of said knowledge assets.
h. A means of application of weighted averaging to independent variables of knowledge assets as a method of applying feedback and or human experiential wisdom to regression equations that provides probabilistic outcomes.
i. Adapting feedback from empirical outcomes of Innovation Banking Transactions for the purpose of improving regression algorithm and decreasing variance in future expectations.
j. Means of identifying advantageous or detrimental risk exposures either through the identification of exposure and/or probability that such exposure would manifest and/or identification of consequences associated with predicted outcome of such risk exposure.
k. Providing a means for amalgamating knowledge assets and assigning them to shared risk pools for the purpose of insurability.
l. A means for knowledge asset enterprise utilizing techniques common and appropriate to financial analysis for the purpose of assessing risk and return, supply and demand, cause and effect, appreciation and depreciation utilizing generally accepted accounting practice in the context of an innovation bank.
m. A means to monetizing knowledge assets.

2. A method of conducting business as recited in claim 1; comprised of a derivative/integral relationship among three factors of production for an innovation economy, Information, Knowledge and Innovation, according to the following associations:
a. Innovation is the rate of change of knowledge with respect to time
b. knowledge is the rate of change of information with respect to time.

3. A method of conducting business as recited in claim 1: an Innovation Bank comprised of the monetization of knowledge species with factors of production whereas;
a. Explicit knowledge is the currency of trade for information
b. Experiential context is the currency of trade for knowledge
c. Tacit knowledge is the currency of trade for innovation

4. A method for conducting business as recited in claim 1 where knowledge assets are inventoried and correlated to three knowledge asset families: Intellectual Capital, Social Capital, Creative Capital, and inclusive of independent variables subservient to the above.

5. A method for conducting business as recited in claim 1 consisting of a technique for a standardized categorization system combined with a technique related to an accrediting/vetting apparatus by Communities of Practice for the formation of knowledge assets in a normal distribution constituting a knowledge inventory system whereas:
a. Communities of practice act necessarily as accrediting institutions related to the vetting of practitioners and their associated body of knowledge.
b. The known method of Universal Decimal Classification or similar is utilized in a novel manner for standard categorization of retained human knowledge in a financial instrument.

6. A method of conducting enterprise as recited in claim 1 consisting of an elemental Unit Business Method (UBM) comprised of a unit knowledge surplus and a unit knowledge deficit connected by analytical means for matching the same in a closed system yielding a unit increase in value resulting from the transaction.

7. A method of conducting business as recited in claim 1 consisting of two or more Unit Business Methods assembled in parallel and/or series where the output of one transaction becomes the input of the next transaction resulting in continuous improvement progression or exponential growth of knowledge assets; the growth rate of which is descriptive of a state of innovation.

8. A method of conducting business as recited in claim 1 comprised of a combination of one or more Unit Business Methods arranged in parallel and/or series circuits of unlimited variety and complexity having specific novelty and utility acting in the context of the Innovation Bank as a means of matching the most worthy knowledge surplus with the most worthy knowledge deficit and increase in value resulting from the system of transactions.

9. A method of conducting business as recited in claim 1 enabled by this invention consisting of interconnected processing elements that work together exhibiting the behavior similar to that of a neural network having fault tolerance and self correcting characteristics to produce an output function having specific utility for modeling observed socioeconomic behavior in a fair market for knowledge assets.

10. A business method enabled by this invention as recited in claim 1 comprised of an Innovation Bond that is securitized and tradable in financial markets, diversified through risk exposure pooling, and returning predictable productivity, as a means of funding large scale integrated innovation as determinable through an innovation bank and associated knowledge inventory and analysis provisions.

11. A business method enabled by this invention as recited in claim 1 for hedging applied knowledge assets and associated innovation probability such that innovation insurance is a marketable enterprise causing aggregate innovation risk to approach zero.

12. A method of conducting business enabled by this invention as recited in claim 1 and applicable to contingency claims in a Black-Scholes formulation (and variations), that is, a means for assessing strategic value as the difference between two or more contingencies related to the deployment of knowledge assets. Specifically, a method of business that provides output for which a premium, strike price, and volatility may be formulated as a means of determining worthiness among knowledge surpluses, knowledge deficits, and their association thereof.

13. A method of conducting business enabled by this invention as recited in claim 1 comprised of tradable options generated in a knowledge inventory as a result of a heuristic stochastic process of invention thus yielding predictable option exercise scenarios when matching most worthy surplus to deficit in an Innovation Bank.

14. A business method enabled by this invention as recited in claim 1 providing a means for adapting feedback in a problem solving environment from empirical outcomes of Innovation Banking transactions for the purpose of improving regression algorithm, decreasing variance in future expectations, specifying volatility of real options, and preserving business intelligence/institutional wisdom whereas improvements are exhibited:
a. Rewarding entrepreneurial behavior toward high utility and high integrity
b. Punishing fraud, breach of contract, negligence, incompetence and misconduct
c. Rewarding market driven interaction, competition, and cooperation among similar or dissimilar Communities of Practice
d. Understanding of cause and effect embodied in entrepreneurial spirit, knowledge ownership.
e. Simulating of wisdom applicable as a tradable asset in an Innovation Bank.
f. Trading in ‘wisdom’ as a comparative reference filter
g. Improving identification of risk exposures in a given knowledge inventory.
h. Improving ability to quantifying dynamic knowledge deficit and/or surplus.
i. Improving ability to reallocate assets among knowledge inventories.

15. A business method enabled by this invention as recited in claim 1 comprised of managing risks related to predictable and designable allocations of knowledge assets thereby reducing risk to knowable values or through diversification, a condition approaching zero in the context of Innovation Banking whereas exists:
a. Provisions for pooling similar risk exposures for the purpose of insurability
b. Assignment of value to consequences of risk exposure
c. capability for calculating premiums on innovation insurance.

16. A business method enabled by this invention as recited in claim 1 and comprised of an innovation bond, securitized and tradable in financial markets, diversified through risk exposure pooling, and returning predictable knowledge asset productivity, as a means of funding large scale integrated innovation as determinable through an innovation bank and associated knowledge inventory and analysis provisions.

17. A business method enabled by this invention as recited in claim 1 providing for insurance products market for hedging knowledge assets productivity and associated innovation where trade in innovation risk is in itself, a marketable enterprise.
